(19) United States
(12) Patent Application Publication
(10) Pub. No.: US 2001/0032959 A1
(43) Pub. Date: Oct. 25, 2001

(54) Valve collect for desmodromic engine

(75) Inventors: John Parker, Montreal (CA); Guy Martin, Pointe-Claire (CA)

Correspondence Address: MCDERMOTT, WILL & EMERY, 600, 13th Street, North-West, Washington, DC, 20005-3096, US

(73) Assignee: 3719294 CANADA INC.

(21) Appl. No.: 09/778,770

(22) Filed: Feb. 8, 2001

Related U.S. Application Data
(60) Provisional application No. 60/183,352, filed on Feb. 18, 2000.

(51) Int. Cl. F16K 1/00

(52) U.S. Cl. 251/337

(57) ABSTRACT

A valve collet concentrically mounted onto a circumferential groove of a valve of a desmodromic valve system for retaining a shim concentrically mounted on the valve of the desmodromic valve system, the shim having an inside surface of a given shape. The valve collet comprises an inner surface having an interlocking portion in the shape of the circumferential groove, the interlocking portion being interlocked with the circumferential groove. The valve collet further comprises an outer surface protruding away from the interlocking portion, the outer surface having a retaining portion matching the shape of the inside surface of the shim and cooperating with the same so as to have an increased contact area with the inside surface and thereby to improve retaining of the shim. Preferably, the inner surface of the valve collet comprises a securing portion extending longitudinally along the valve so as to secure mounting of the valve collet on the valve. Because of its increased contact area with the shim and because of its design, the valve collet does not quickly wear out and/or change in shape, remains properly seated in its bedded position, and thus extends the time interval allowable between regular valve adjustments.

### FIELD OF THE INVENTION

The invention relates to a valve collet like those used in valve systems and the like. More particularly, the invention relates to a redesigned and improved valve collet for use to retain shims on desmodromic valve systems.

### BACKGROUND OF THE INVENTION

Motorcycles and valve systems thereof are well known in the art. It is also known that Ducati Motors™ is a well renowned motorcycle manufacturer. So far, Ducati Motors™ way of retaining the valves in their famous desmodromic valve systems is by means of a hardened annular piece of wire cut in half, known as a “valve collet” or simply “collet”, and also known as “half rings”, a “valve keeper”, or a “valve lock”. This approach was adequate in the early 60's, when engines were not under too much stress and high revolution engines were virtually unknown.

However, nowadays, with the new technology of the high revving engine and its added stress factor, the above-mentioned collets are obsolete. Therefore, it would be useful to provide a new approach of retaining the shims on the famous desmodromic valve systems by redesigning the valve collets.

Because of the circular-shaped cross-sectional geometry of the valve collets of the prior art, the latter have a small contact area with the shims with which they cooperate. Hence, the contact area possible between valve collet and shim is not fully utilized. Therefore, it would be useful to provide a valve collet which would have an increased contact area with the shim with which it cooperates.

A small contact area usually implies a low precision of fit which generally results in looseness, and looseness causes wear. As a result thereof, the collets known in the art tend to quickly wear out and/or change in shape, especially when employed with today's very demanding high revving engines. Therefore, it would be useful to provide a valve collet which would not quickly wear out and/or change in shape.

Moreover, because of their small contact area and hence loose fit inherent to the above-described geometry, the collets known in the art also tend to become unseated from their bedded position in the closing shim, which may also result in serious adverse consequences in terms of safety and performance. Therefore, it would be useful to provide a valve collet which would remain properly seated in its bedded position.

Furthermore, valve adjustments are a necessary but also very costly task. However, if not performed as suggested, the change of clearances of the valves can lead to extensive damage to the engine, either by burning the valves due to poor valve adjustment caused by wear of the above-mentioned collets, or by the collets disintegrating which occasionally leads to the valve falling into the cylinder causing extreme internal engine damage. Hence, Ducati Motors™ recommends a valve adjustment every 3,000 miles (5,000 km) in order to monitor the wear on the valve collets presently being used. However, this represents a relatively small time interval between valve adjustments, which means less time on the road and more time in the repair shop. Furthermore, frequent valve adjustments translate into high expenditures for users of the above-described collets. Therefore, it would be useful to provide a valve collet which would extend the time interval allowable between regular valve adjustments.

### SUMMARY

The object of the present invention is to provide a valve collet which satisfies each of the above-mentioned needs.

More particularly, a first object of the present invention is to provide a new approach of retaining the shims on the desmodromic valve systems by redesigning the valve collets.

A second object of the present invention is to provide a valve collet which has a larger contact area with the shim with which it cooperates than that what is possible with the valve collets known in the art.

A third object of the present invention is to provide a valve collet which does not quickly wear out and/or change in shape when compared to the valve collets known in the art.

A fourth object of the present invention is to provide a valve collet which, because of its design, maintains itself properly seated in its bedded position.

A fifth object of the present invention is to provide a valve collet which extends the time interval allowable between regular valve adjustments.

A sixth object of the present invention is to provide a valve collet which enables for a more environmentally sound operation of the engine by reducing polluting emissions.

According to the present invention, the above object is achieved by a valve collet concentrically mounted onto a circumferential groove of a valve of a desmodromic valve system for retaining a shim concentrically mounted on the valve of said desmodromic valve system, said shim having an inside surface of a given shape, said valve collet comprising:

an inner surface having an interlocking portion in the shape of the circumferential groove, said interlocking portion being interlocked with the circumferential groove, and

an outer surface protruding away from the interlocking portion, said outer surface having a retaining portion matching the shape of the inside surface of the shim and cooperating with the same so as to have an increased contact area with the inside surface and thereby to improve retaining of said shim.

The invention and its advantages will be better understood upon reading the following non-restrictive description of a preferred embodiment thereof, made with reference to the accompanying drawings.

### BRIEF DESCRIPTION OF THE DRAWINGS

FIG. 1 is a partial front sectional view of a desmodromic valve system using a valve collet according to the prior art.

FIG. 2 is a partial front sectional view of the valve system shown in FIG. 1 using a valve collet according to a preferred embodiment of the invention.

FIG. 3 is a partial perspective view of the valve system of FIG. 1, said valve system being shown with a top shim.

FIG. 4 is a partial perspective view of the valve system of FIG. 2, said valve system being shown with a top shim.

FIG. 5 is an exploded perspective view of what is shown in FIG. 3.

FIG. 6 is an exploded perspective view of what is shown in FIG. 4.

FIG. 7 is a perspective view of the valve collet shown in FIG. 1.

FIG. 8 is a perspective view of the valve collet shown in FIG. 2.

FIG. 9 is a perspective view of one valve collet shown in FIG. 8.

FIG. 10 is a partial front sectional view of another desmodromic valve system using a valve collet according to the prior art.

FIG. 11 is a partial front sectional view of the valve system shown in FIG. 10 using a valve collet according to another preferred embodiment of the invention.

FIG. 12 is a perspective view of the valve collet shown in FIG. 11.

FIGS. 13a to 13g are partial front sectional views of other desmodromic valve systems using valve collets according to other preferred embodiments of the invention.

### BRIEF DESCRIPTION OF A PREFERRED EMBODIMENT OF THE INVENTION

In the following description, the same numerical references refer to similar elements. The embodiments shown in the figures are preferred. As known in the prior art, a “valve collet”, or simply “collet”, is also known as “half rings”, a “valve keeper”, or a “valve lock”, and in the context of the present description, the latter expressions may be used interchangeably.

Although the present invention was primarily designed for a motorcycle valve system, and more particularly, for a desmodromic valve system, it may also be used with other kinds of valve systems pertaining to other types of vehicles, such as cars, trucks, and the like, or with any other engines using valve systems, as apparent to a person skilled in the art. For this reason, the expression “desmodromic valve system” should not be taken as to limit the scope of the present invention and includes all other kinds of valve systems with which the present invention may be useful.

The valve collet 1 according to the preferred embodiment of the invention as it is illustrated with accompanying drawings is a valve collet 1 concentrically mounted onto a circumferential groove 3 of a valve 5 of a desmodromic valve system 7 for retaining a shim 9 concentrically mounted on the valve 5 of the desmodromic valve system 7. The shim 9 has an inside surface 11 of a given shape and the valve collet 1 comprises an inner surface 13 and an outer surface 15. The valve collet 1 is characterized in that its inner surface 13 has an interlocking portion 17 in the shape of the circumferential groove 3 so as to be interlocked therewith. The valve collet 1 is further characterized in that its outer surface 15 protrudes away from the interlocking portion 17 and has a retaining portion 19 matching the shape of the inside surface 11 of the shim 9. As a result of that, the outer surface 15 of the valve collet I cooperates with the inside surface 11 of the shim 9 so as to have an increased contact area therewith and thereby to improve retaining of the shim 9. Preferably, the inner surface 13 of the valve collet 1 further comprises a securing portion 21 extending longitudinally along the valve 5 so as to secure mounting of the valve collet 1 onto the valve 5.

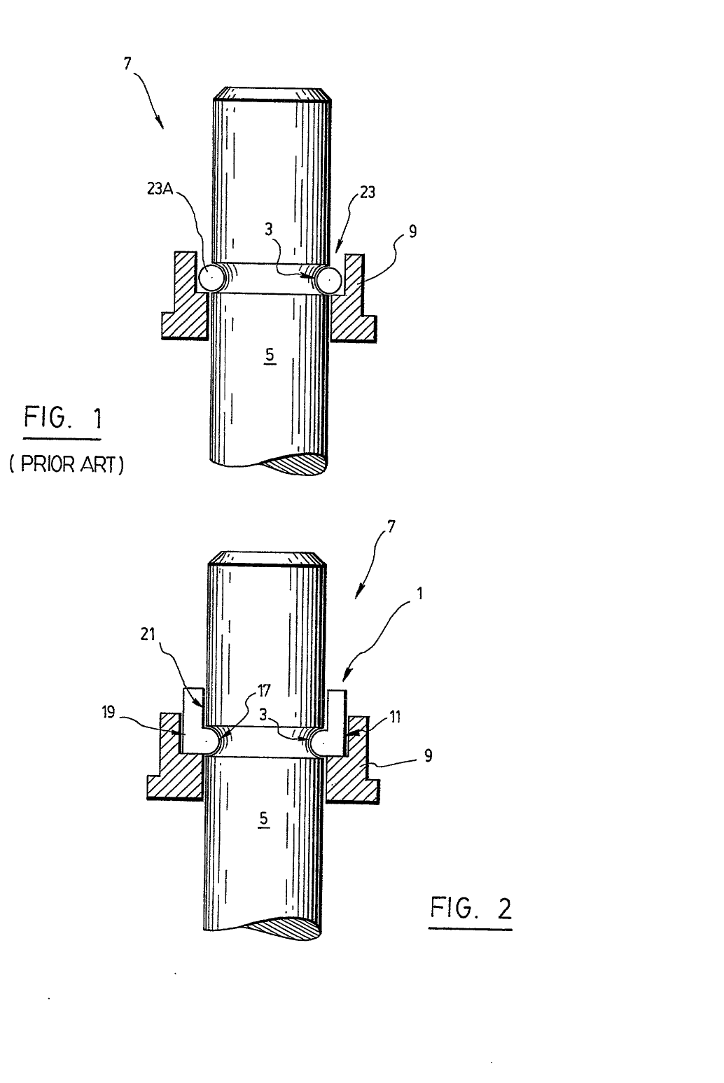

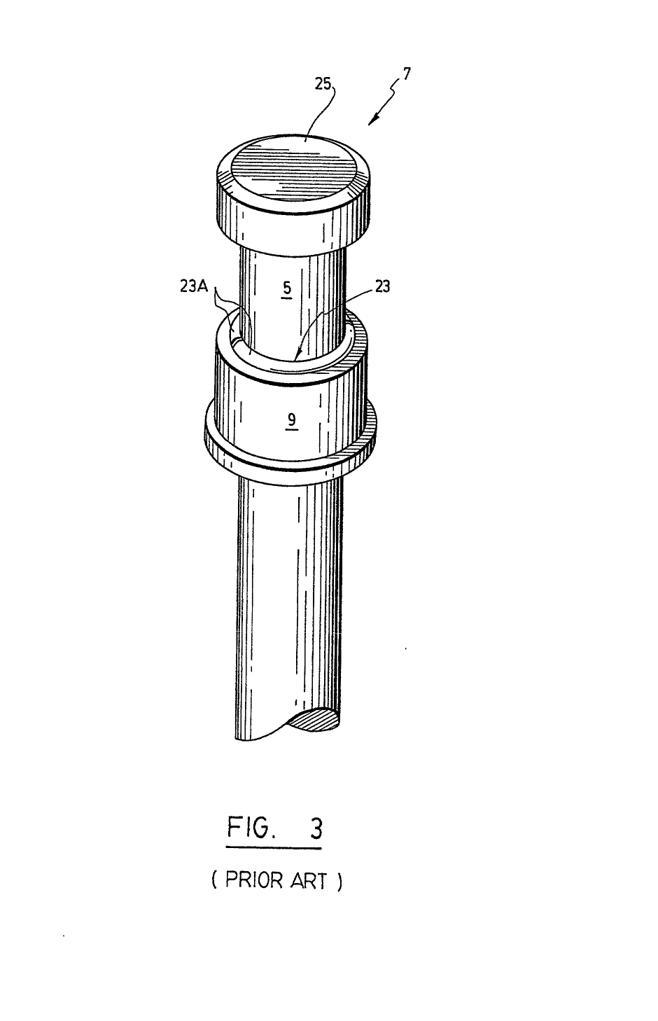

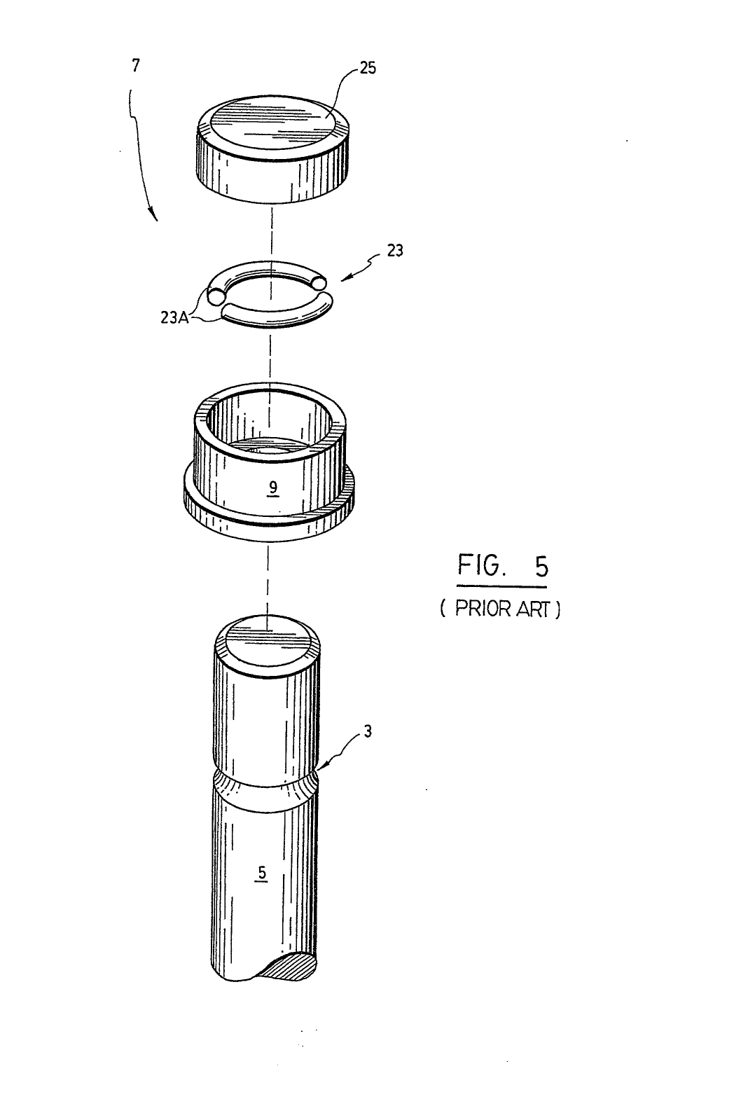

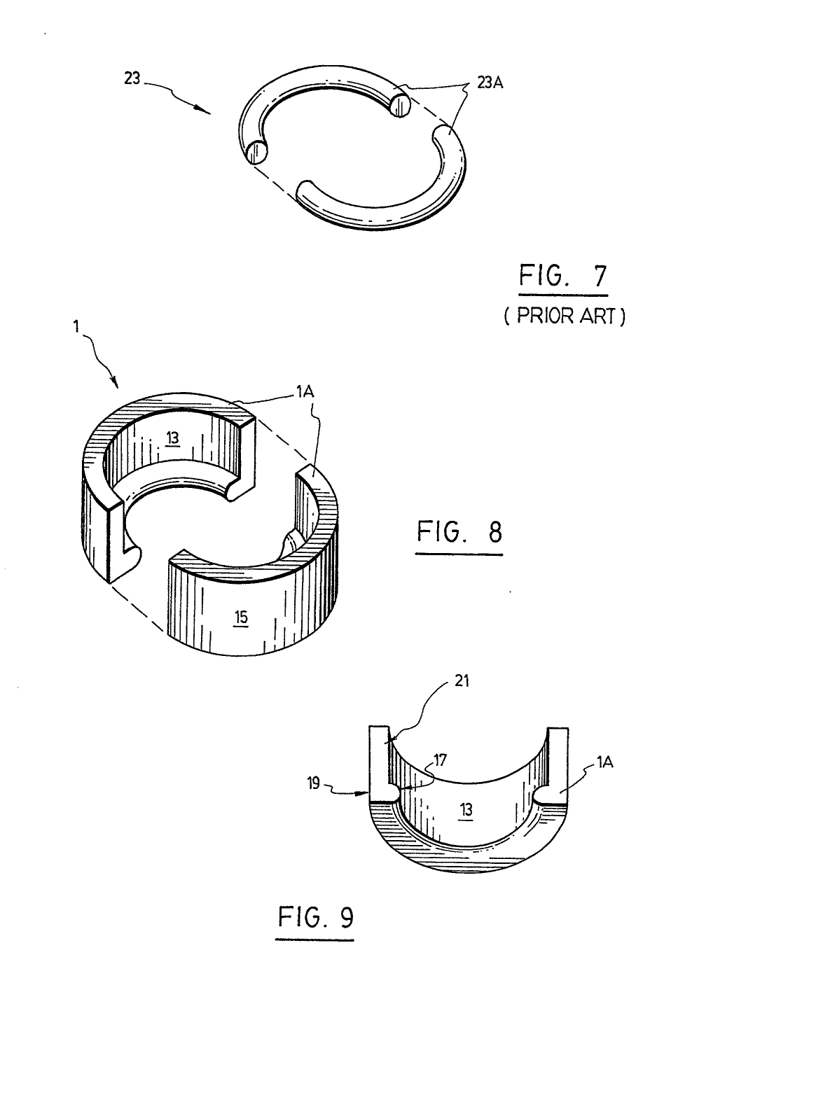

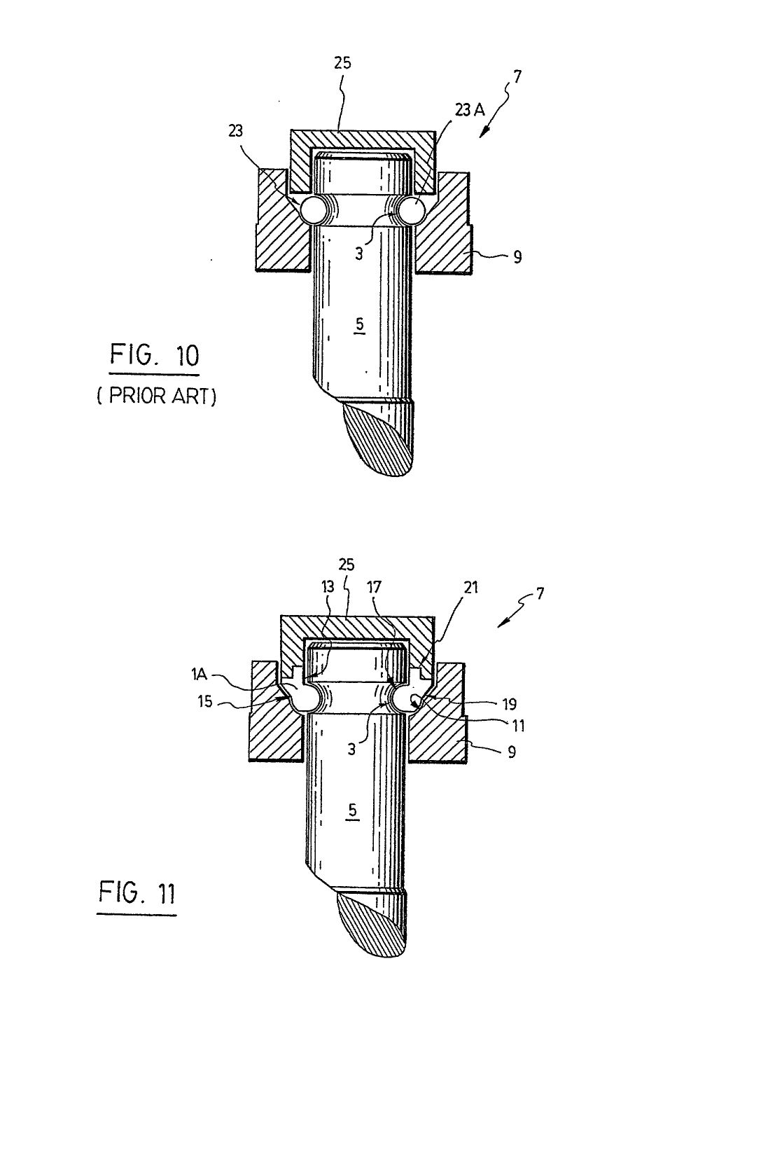

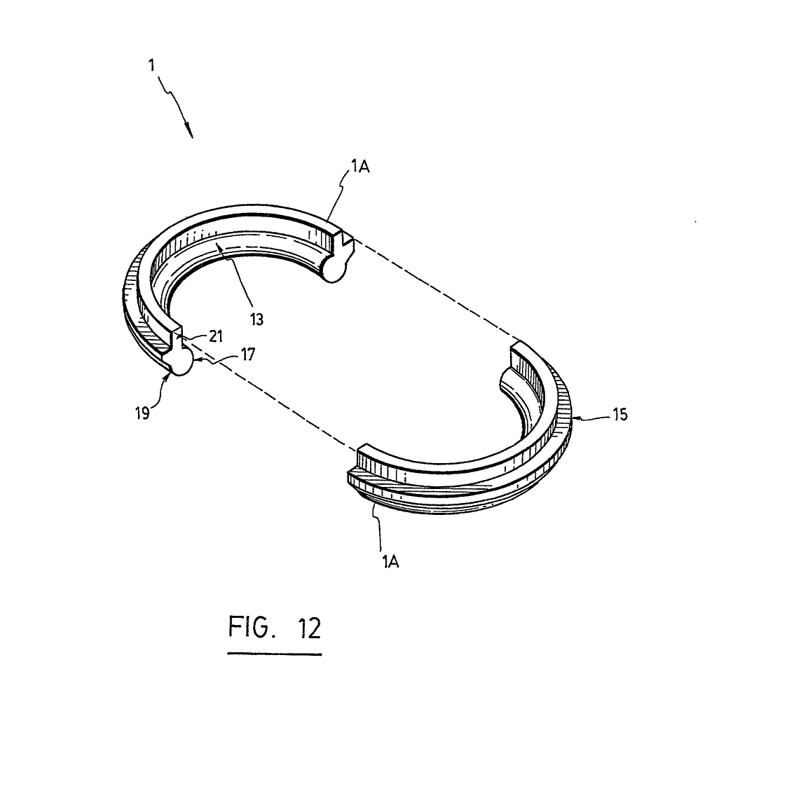

Referring now to FIG. 1, one can see a partial front sectional view of a valve system 7 using a valve collet 23 according the prior art. The valve system 7 essentially comprises a valve 5, a closing shim 9, and a top shim 25, the latter being better shown in FIGS. 3 and 5. The valve collet 23 shown in FIG. 1 is simply a hardened annular piece of metallic wire cut in half, resulting in two pieces which are known as “half rings” 23a. Hence, each valve collet 23 generally comprises two annular “half rings” 23a, as better shown in FIG. 7. The valve collet 23 is used for retaining of the closing shim 9, that is, more particularly, the valve 5 and the closing shim 9 cooperate with each other by means of the valve collet 23. As better shown in FIG. 1, because of its circular-shaped cross-sectional geometry, the valve collets 23 of the prior art have a small contact area with the shims 9 with which they cooperate. The contact area is thus limited to only a few contact points, as also better shown in FIG. 1.

Referring now to FIG. 2, the valve collet 1 according to the preferred embodiment of the invention is preferably concentrically mounted onto the circumferential groove 3 of the valve 5 of the desmodromic valve system 7 for retaining the shim 9 which is, preferably also, concentrically mounted on the valve 5 of the same desmodromic valve system 7. The valve collet 1 comprises an inner surface 13 having an interlocking portion 17 in the shape of the circumferential groove 3, the interlocking portion 17 being interlocked with the circumferential groove 3. The valve collet 1 further comprises an outer surface 15 protruding away from the interlocking portion 17, the outer surface 15 having a retaining portion 19 matching the shape of the inside surface 11 of the shim 9 and cooperating with the same so as to have an increased contact area with the inside surface 11, as opposed to the valve collet 1 of FIG. 1, and thereby to improve retaining of the shim 9.

As better shown in FIG. 2, the contact area possible between the inside surface 11 of the closing shim 9 and the outer surface 15 of the valve collet 1 is fully utilized in that the valve collet's retaining portion 19 is designed so as to match the shape of the shim's inside surface 11. Similarly, as also better shown in FIG. 2, the contact area between the circumferential groove 3 of the valve 5 and the valve collet's inner surface 13 is fully utilized in that the valve collet's interlocking portion 17 is designed so as to match the shape of the valve's circumferential groove 3. As a result of the aforementioned, there is an increased if not maximum contact area between the valve collet I and the components, i.e. valve 5 and closing shim 9, with which it cooperates. This results in a very high precision of fit which substantially diminishes wear and thus prevents the valve collet 1 from wearing out quickly and/or changing in shape. Hence, a longer time interval may be allowed between regular valve adjustments.

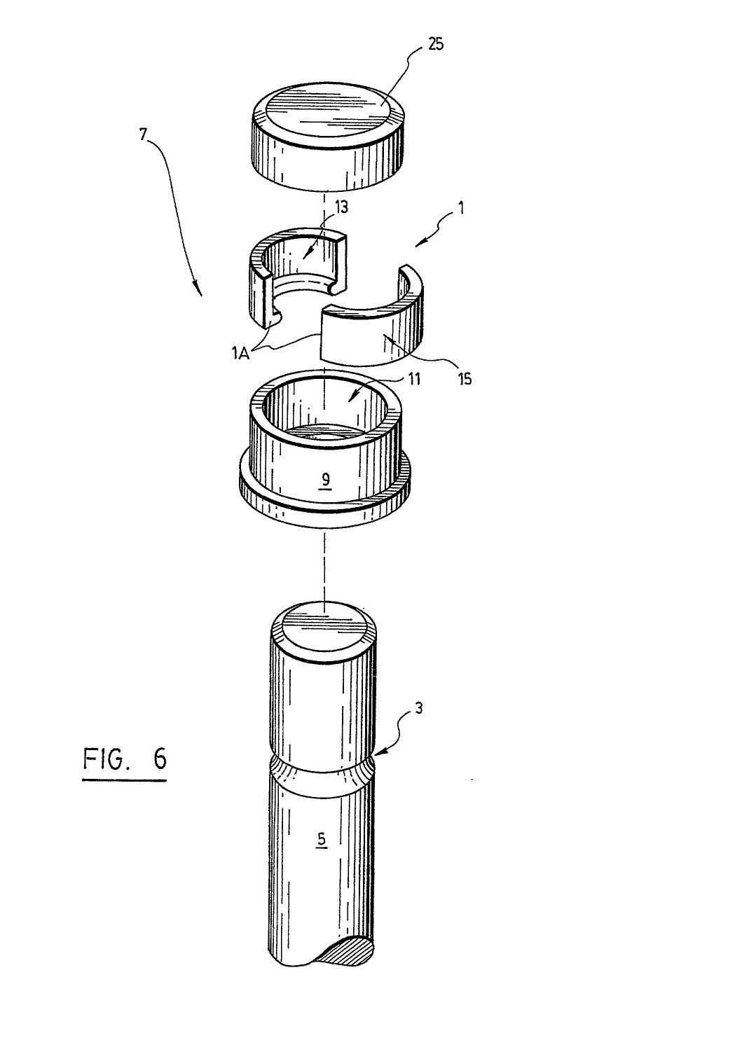

As shown in FIG. 2, the inside surface 11 of the closing shim 9 is preferably L-shaped. Consequently, the retaining portion 19 of the valve collet 1 is also preferably L-shaped, as better shown in FIGS. 2, 4, 6, 8, and 9. The reason being that, in response to a given shape of the inside surface 11 of the closing shim 9, the retaining portion 19 of the valve collet I is devised accordingly, that is, is devised to have a corresponding matching shape. As also shown in FIG. 2, the circumferential groove 3 of the valve 5 is preferably annular in shape. Consequently, the interlocking portion 17 of the valve collet 1 is also preferably annular in shape. Similar to the aforementioned, the reason is that in response to a given shape of the circumferential groove 3 of the valve 5, the interlocking portion 17 of the valve collet 1 is devised accordingly, that is, is devised to have a corresponding matching shape.

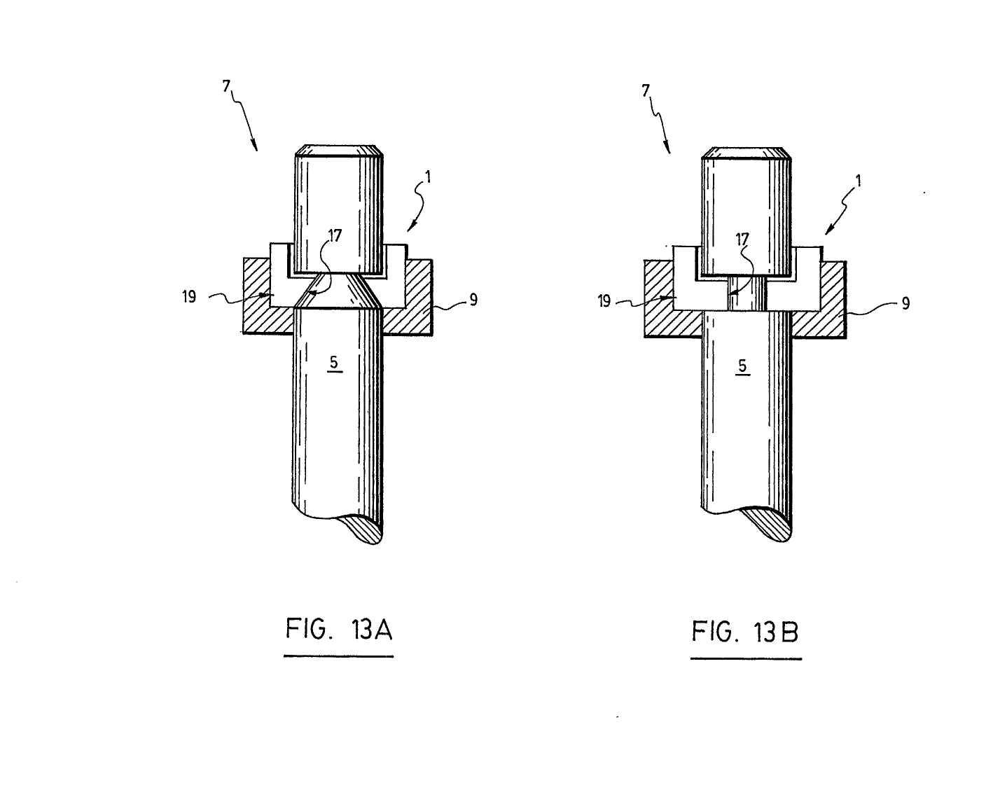

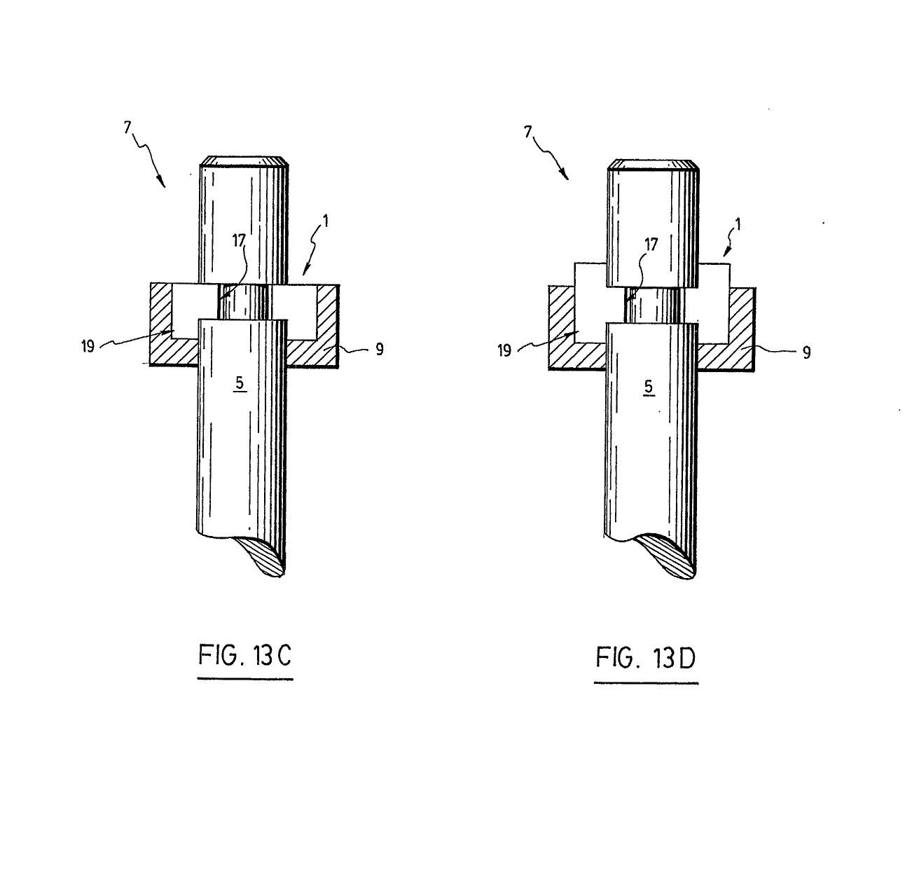

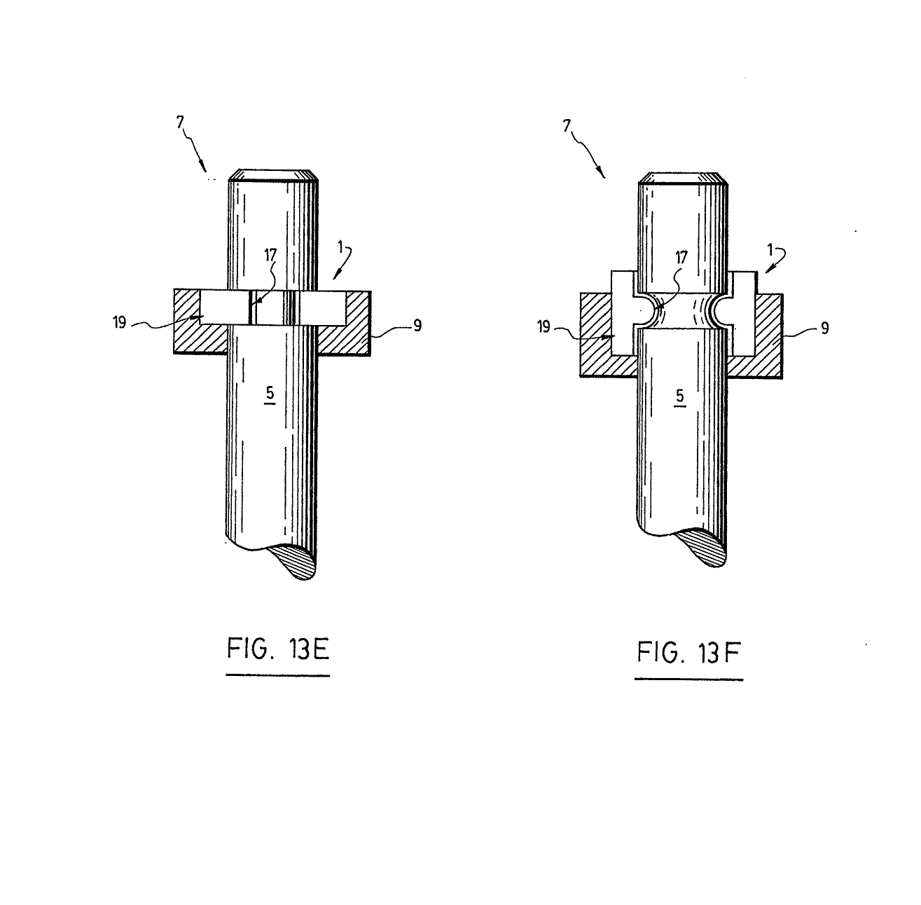

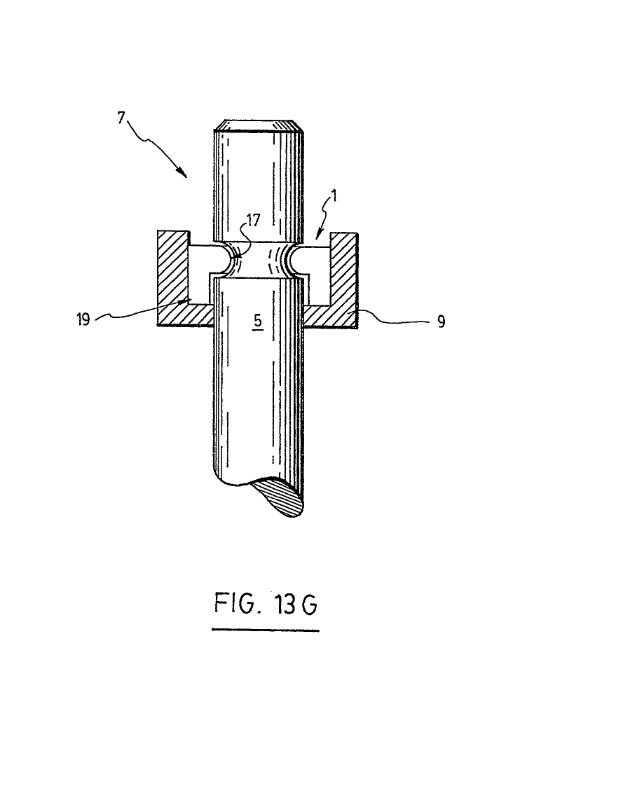

It is to be understood that the scope of the invention is not limited to the valve collet's preferred L-shaped retaining portion 19 nor is it limited to its preferred annular-shaped interlocking portion 17. Indeed, it is worth noting that the valve collet 1 according to the invention, in order to better match, increase contact area with and thus improve retaining of the closing shim 9, may take on various other shapes and/or configurations, as better shown in FIG. 11, so as to correspondingly match with the shape of the inside surface 11 of the closing shim 9, whatever the latter may consist of, and in order also to fulfill the particular needs of each specific valve system 7, as apparent to a person skilled in the art. Hence, the shape of the retaining portion 19 need not be necessarily rectilinear, and may take on any other arbitrary configuration in order to match the specific shape of the inside surface 11 of a given closing shim 9, as shown in FIGS. 13a to 13g. Similarly, the shape of the interlocking portion 17 of the valve collet 1 may take on any other arbitrary configuration in order to match the specific shape of the circumferential groove 3 of a given valve 5, as shown in FIGS. 13a to 13g.

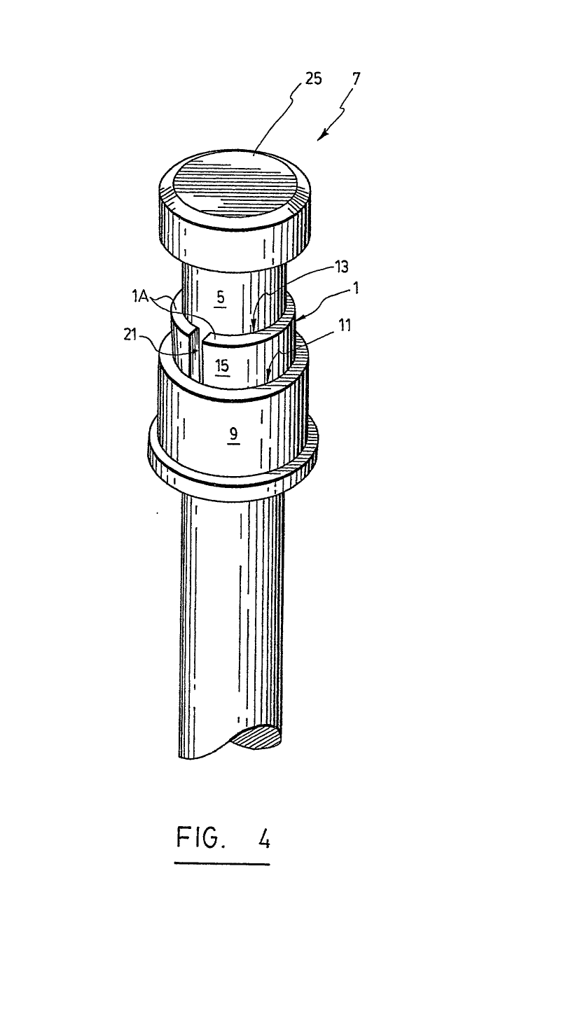

As better shown in FIG. 2, the inner surface 13 of the valve collet 1 preferably further comprises a securing portion 21 extending longitudinally along the valve 5 so as to secure mounting of the valve collet 1 on the valve 5. Preferably also, as better shown in FIG. 4, the securing portion 21 of the valve collet 1 extends past the upper edge of the closing shim 9, without reaching the top shim 25, at an appropriate distance therefrom, as apparent to a person skilled in the art. The securing portion 21, together with the interlocking portion 17 and the retaining portion 19 which matches the inside surface 11 of the closing shim 9, also ensures that the valve collet 1 does not quickly wear out and/or changes in shape, because it maintains the valve collet 1 snugly fit in the closing shim 9. Furthermore, the securing portion 21, together with the interlocking portion 17 and the retaining portion 19 which matches the inside surface 11 of the closing shim 9, further ensures that the valve collet 1 continuously maintain itself properly seated in its bedded position in the closing shim 9, thus ensuring appropriate cooperation between valve 5 and closing shim 9. It is worth noting that, as better shown in FIG. 11, the securing portion 21 and the top shim 25 may be modified so as to complement one another, depending on the applications intended for the valve collet 1 and on the type of valve system 7 being used, as apparent to a person skilled in the art. FIG. 11 shows a preferred embodiment of the valve collet 1 and top shim 25 for a four (4) valve Ducati Motors™ system 7.

As better shown in FIGS. 2, 6, 8, and 9, the valve collet 1, including the retaining, interlocking and securing portions 19, 17, 21, has preferably a b-shaped cross-section. However, as aforementioned, the interlocking portion 17 is designed to match and snug the shape of the circumferential groove 3 and its surroundings, and the retaining portion 19 is designed to match and snug the shape of the inside surface 11 of the closing shim 9, irrespectively of which shape and/or form they may take on, as long as it is intended for maximum contact area between the valve collet 1 and the components with which it interacts. Hence, the valve collet 1, including the retaining, interlocking and securing portions 19, 17, 21, may have cross-sections of different other shapes, such as L-shaped for example.

As better shown in FIGS. 8 and 9, the valve collet 1 is preferably cut longitudinally into at least two pieces along at least one plane coplanar to a longitudinal axis of the valve 5. Preferably, the valve collet 1 is cut into two pieces, as better shown in FIG. 8, each known as a “collet” 1a, as shown in FIG. 9. By cutting the valve collet 1 as such, it allows for it to be easily and appropriately mounted onto the valve 5 of the valve system 7. It is worth noting that the valve collet 1 could be cut into more pieces, three for example, but two pieces are usually an adequate number for most intended purposes, as apparent to a person skilled in the art.

The present invention is an improvement and presents several advantages over the valve collets 23 known in the prior art, such as the one illustrated in FIG. 1, in that, as demonstrated hereinabove, the present invention constitutes a new approach of retaining the shims 9 of valve systems 7. For instance, the valve collet 1 according to the present invention has a larger contact area with the shim 9 with which it cooperates than that what is possible with the valve collets 23 known in the prior art. As can be easily seen when comparing to FIG. 1, instead of having only a few contact points, the valve collet 1 according to the present invention has an increased contact area. This is due to the fact that the interlocking portion 17 of the valve collet 1 is devised to match the shape of the circumferential groove 3 and that the retaining portion 19 of the valve collet 1 is devised to match the shape of the inside surface 11 of the closing shim 9. Because of its increased area, the valve collet 1 has a higher precision of fit and thus eliminates any looseness which causes wear. Furthermore, because of its retaining, interlocking and securing portions 19, 17, 21, the valve collet 1 does not wear out and/or change in shape as quickly as the valve collets 23 known in the prior art. Moreover, as explained earlier, the design of the present invention enables the valve collet 1 to maintain itself properly seated in its bedded position. As a result of the aforementioned, and after long research and testing, tests have shown that the valve collet I according to the present invention can outperform the valve collet 23 shown in FIG. 1 by tripling the time allowable between regular valve adjustments. Because the valve collet 1 according to the present invention does not wear out and/or change in shape as quickly as the valve collets 23 of FIG. 1, valve adjustments are only needed for normal bedding wear of valves and seats.

Further to the above-described advantages of the present invention, there is also the tremendous market potential. Although the valve collets 1 have been primarily designed to be used with Ducati Motors™ motorcycles, they could ultimately be used for various other types of valve systems. In fact, 350 000 desmodromic motors have been produced by Ducati Motors™ since the early 60's, 225 000 of which have been produced since 1990. The year 2002 has a forecast production of 50 000 units per year. Hence, there is a net increase in the number of Ducati Motors™ engines being produced each year. Furthermore, these engines include singles (2 valves), Twins (4 valves) and the new generation of Twins (8 valves). Considering an average of 4 valves 5 per engine, multiplied by 350 000 engines, one obtains 1.4 million valves 5 whose collets are going to need to be replaced. Reaching only 20% of this market would translate into a demand of 280 000 collets 1. Collets are a small but essential part of regular engine maintenance. The valve collets 1 according to the present invention can eliminate more than half the valve adjustments at a cost of $250 US each time for a 4 valve, price for an 8 valve adjustment can go up to $700 US. Thus, the valve collets 1 according to the present invention could pay for themselves in less than one valve adjustment allowing for more time on the road and less time in the repair shop, with the added benefit of greater mechanical reliability with less than half of the usual valve adjustment costs.

Moreover, the present invention is an improvement over the valve collets available in the trade in that, as apparent to a person skilled in the art, the present invention enables to keep the engine with which it is used in “perfect tune”, which in turn enables to have a reduced amount of polluting emissions from the engine. Hence, the present invention is advantageous in that it enables for a more environmentally sound operation of the engine.

As aforementioned and as it is evident from reading the above description, although the present invention was primarily designed for a motorcycle valve system 7, and more particularly, for a desmodromic valve system 7, it may be used with other kinds of valve systems 7 pertaining to other types of vehicles, such as cars, trucks, and the like, or with any engines using valve systems 7 with which the present invention may be useful, as apparent to a person skilled in the art. As also apparent to a person skilled in the art, the present invention may be manufactured and enhanced mechanically using various processes, such as military-spec billet steel alloys and/or vacuum melted steels, fully computerized numerical control (C.N.C.) machined, vacuum furnace heat treatment, tinanium nitrate coating, electric discharge machining (E.D.M.) cutting, and individual inspection.

The present invention is thus a substantial improvement over the prior art in that, among many other things, it is a more reliable, easier to maintain, safer and more cost-effective valve collet 1, resulting in improved performance and efficiency.

Of course, numerous modifications could be made to the above-described embodiments without departing the scope of the invention as defined in the appended claims.

1. A valve collet concentrically mounted onto a circumferential groove of a valve of a desmodromic valve system for retaining a shim concentrically mounted on the valve of said desmodromic valve system, said shim having an inside surface of a given shape, said valve collet comprising:
an inner surface having an interlocking portion in the shape of the circumferential groove, said interlocking portion being interlocked with the circumferential groove, and
an outer surface protruding away from the interlocking portion, said outer surface having a retaining portion matching the shape of the inside surface of the shim and cooperating with the same so as to have an increased contact area with the inside surface and thereby to improve retaining of said shim.

2. A valve collet according to claim 1, wherein the inner surface of the valve collet further comprises a securing portion extending longitudinally along the valve so as to secure mounting of the valve collet on the valve.

3. A valve collet according to claim 1, wherein the circumferential groove and the interlocking portion are annular in shape.

4. A valve collet according to claim 1, wherein the inside surface of the shim and the retaining portion are L-shaped.

5. A valve collet according to claim 1, wherein the valve collet is cut longitudinally into at least two pieces along at least one plane coplanar to a longitudinal axis of the valve.

6. A valve collet according to claim 2, wherein the circumferential groove and the interlocking portion are annular in shape.

7. A valve collet according to claim 2, wherein the inside surface of the shim and the retaining portion are L-shaped.

8. A valve collet according to claim 2, wherein the valve collet is cut longitudinally into at least two pieces along at least one plane coplanar to a longitudinal axis of the valve.

9. A valve collet according to claim 8, wherein the valve collet is b-shaped.

10. A valve collet according to claim 8, wherein the valve collet is L-shaped.
